(19) United States
(12) Patent Application Publication
(10) Pub. No.: US 2014/0121786 A1
(43) Pub. Date: May 1, 2014

(54) SMART GATEWAY, SMART HOME SYSTEM AND SMART REMOTE CONTROL METHOD THEREOF

(71) Applicants: HON HAI PRECISION INDUSTRY CO., LTD., New Tapei (TW); HONG FU JIN PRECISION INDUSTRY (ShenZhen) CO., LTD, Shenzhen (CN)

(72) Inventors: TE-SHENG CHEN, New Taipei (TW); XIAO-GUANG LI, Shenzhen (CN); KUAN-HONG HSIEH, New Taipei (TW); YUN XIAO, Shenzhen (CN); SHANG-HUI PI, Shenzhen (CN)

(73) Assignees: HON HAI PRECISION INDUSTRY CO., LTD., New Taipei (TW); HONG FU JIN PRECISION INDUSTRY (ShenZhen) CO., LTD, Shenzhen (CN)

(21) Appl. No.: 14/014,347

(22) Filed: Aug. 29, 2013

(30) Foreign Application Priority Data
Oct. 30, 2012 (CN) 201210423583X

(51) Int. Cl. G05B 15/02

(52) U.S. Cl. CPC G05B 15/02
USPC 700/19

(57) ABSTRACT

A remote controlling method applied to a smart home system for controlling a number of home appliances of the smart home system is provided. A remote controller sends a controlling command to a smart gateway. A smart gateway extracts an operation command and sends a controlling signal including the operation command to the home appliance. The home appliances receive the controlling signal and execute the corresponding operation. A smart gateway and a smart home system are also provided.

### BACKGROUND

1. Technical Field

The present disclosure relates to smart home technology, and particularly to a smart gateway, a smart home system, and a smart remote control method for controlling home appliances of the smart home system and devices.

2. Description of Related Art

Today, smart home technology is more and more popular. With this technology, all home devices in a house are connected to a smart home network system, so as to be controlled in unison, allowing a user to easily control the home devices from anywhere in the house.

Most home appliances or devices need to be coupled to a special controller, which is complicated. Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a schematic view showing a smart home system, according to an exemplary embodiment.

FIG. 2 is a block diagram of the smart home system of FIG. 1.

FIG. 3 is a block diagram of a smart gateway of the smart home system of FIG. 1.

FIG. 4 is a block diagram showing a second Power Line Communication modern unit of home appliances of FIG. 1.

FIG. 5 is a block diagram of a remote controller of the smart home system of FIG. 1.

FIG. 6 is a schematic view showing an operation controlling interface displayed on the remote controller of the smart home system of FIG. 1.

FIG. 7 is a block diagram of the smart home system coupled with a number of registration controllers.

FIG. 8 is a diagram showing a mapping table used in the home system of FIG. 7.

FIG. 9 is a block diagram of the smart home system coupled with only one registration controller.

FIG. 10 is a diagram showing a mapping table used in the home system of FIG. 9.

FIG. 11 is a flowchart illustrating a remote controlling method for controlling the home appliances of the smart home system of FIG. 2, according to an exemplary embodiment.

FIG. 12 is a sub-flowchart of the remote controlling method of FIG. 11.

FIG. 13 is a flowchart illustrating a remote controlling method for controlling the home appliances of the smart home system of FIG. 2, according to another embodiment.

FIG. 14 is a sub-flowchart of the remote controlling method of FIG. 13.

### DETAILED DESCRIPTION

The disclosure, including the accompanying, is illustrated by way of example and not by way of limitation. It should be noted that references to “an” or “one” embodiment in this disclosure are not necessarily to the same embodiment, and such references mean “at least one.”

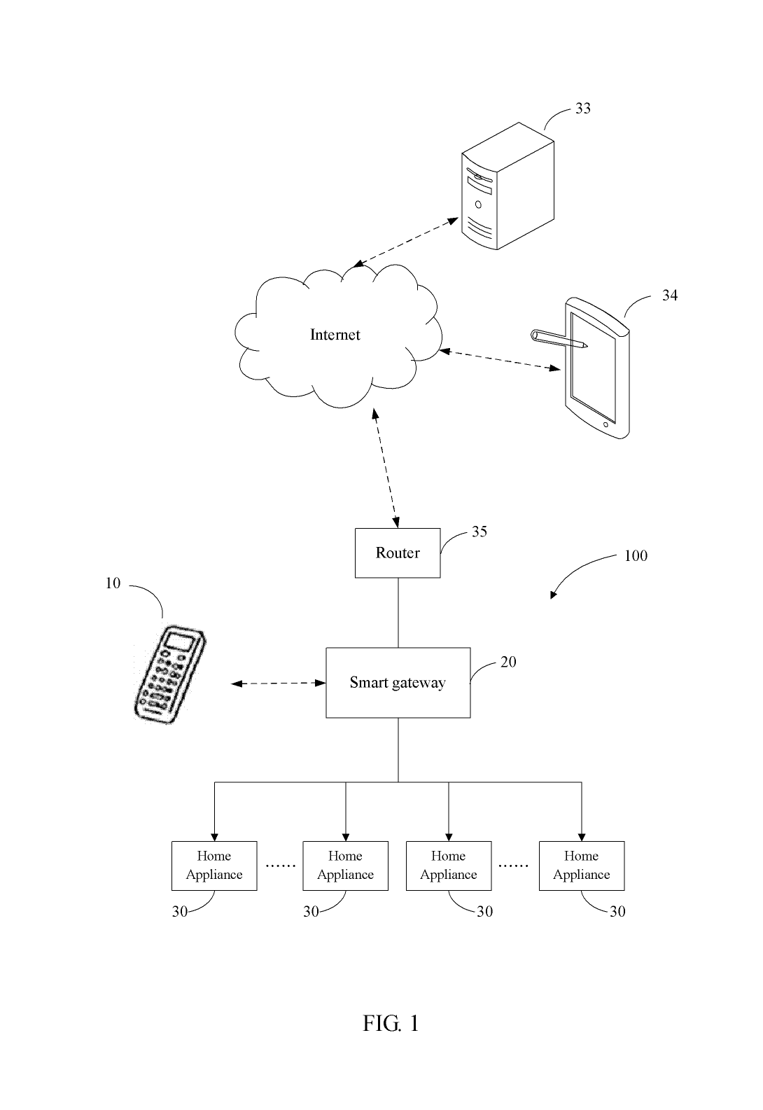

Referring to FIG. 1, a smart home system 100 is provided. The smart home system 100 includes a smart gateway 20 communicating with a server 33 and an Internet controller 34 via the Internet. The smart gateway 20 also communicates with a number of home appliances 30. The smart gateway 20 is connected to a wired or wireless router 35, thereby communicating with the Internet via the router 35. The Internet controller 34 can be a computer, a portable notebook, or the like connecting to the Internet via a wired or wireless Ethernet interface unit. The Internet controller 34 also can be a smart phone, a personal digital assistant (PDA), a tablet PC, or the like connecting to the Internet via the General Packet Radio Service (GPRS) network, the Code Division Multiple Access (CDMA) network, the 3^{rd} Generation (3G) Telecommunication network, the 4^{th} Generation (4G) Telecommunication network, or other networks of mobile Internet. The server 33 also connects to the Internet, thereby communicating with the smart gateway 20 and the Internet controller 34.

In this embodiment, the smart home system 100 further includes a remote controller 10. The remote controller 10 communicates with the smart gateway 20 via a wired or wireless communication mode. The remote controller 10 sends a control command to the smart gateway 20 according to a user's input, and the smart gateway 20 controls the home appliances 30 to execute a corresponding operation according to the control command. Furthermore, the smart gateway 20 receives the control command sent by the server 33 or the Internet controller 34, to control the home appliances 30 to execute the corresponding operations. The wireless communication mode includes, but is not limited to, infrared, Bluetooth, Z-wave, NFC, ZigBee, WIFI, or other communication technologies; the wired communication mode can be Power Line Communication (hereinafter PLC), Optical Fiber Power Line Communication (hereinafter OPLC), wired Internet communication, coaxial cable communication, telephone line communication, or other communication technologies.

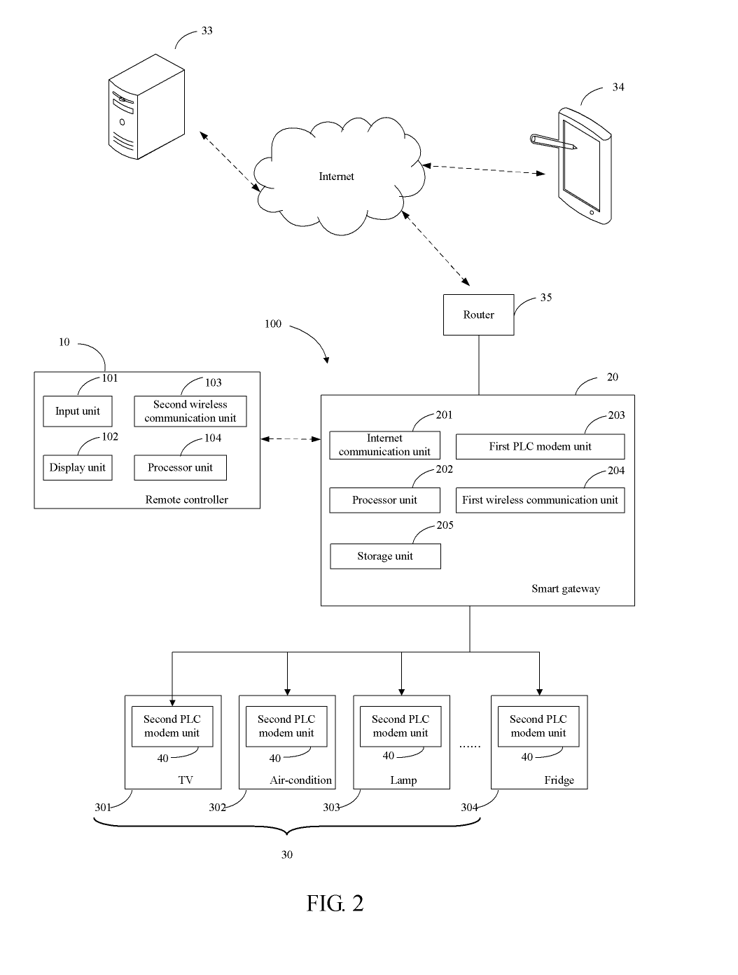

Referring to FIG. 2, a block diagram of the smart home system 100 is provided. The smart gateway 20 includes an Internet communication unit 201, a processor unit 202, a first PLC modem unit 203, a first wireless communication unit 204, and a storage unit 205.

The smart gateway 20 communicates with each of the home appliances 30 via a wired or wireless communication mode, wherein the wireless communication mode includes, but is not limited to, infrared, Bluetooth, Z-wave, NFC, Zigbee, WIFI, or other communication technologies; the wired communication mode can be PLC, OPLC, wired Internet communication, coaxial cable communication, telephone line communication, or other communication technologies. In this embodiment, the smart gateway 20 communicates with the home appliances 30 via the PLC technologies, the smart gateway 20 and parts of the home appliances 30 are connected to the power line. The power line not only supplies power to consumers, but also serves as a carrier for data transmission between the smart gateway 20 and the home appliances 30. In other embodiments, the smart gateway 20 and the home appliances 30 are connected by an Optical Fiber Composite Low-voltage Cable, and communicate with each other via the OPLC technologies.

The storage unit 205 is configured for storing system information of the home system 100. The system information includes a unique identification code (ID) of the home appliances 30, location and setting parameters of the router 35, and verification information of registered users of the smart home system 100. The verification information includes a user name and secret code of the registered user.

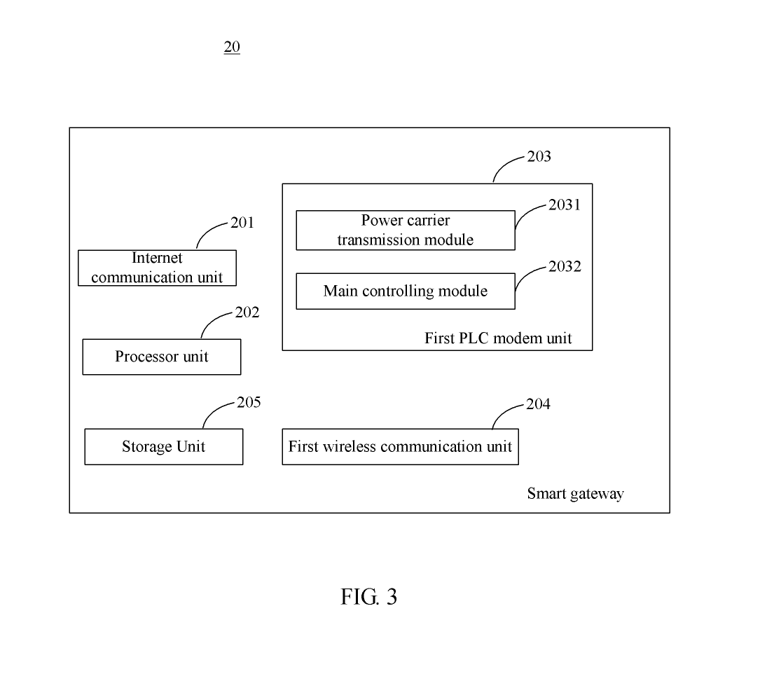

Referring to FIG. 3, the first PLC modem unit 203 includes a power carrier transmission module 2031 and a main controlling module 2032. The main controlling module 2032 is configured for encoding and transmitting data. The power carrier transmission module 2031 is configured for loading electronic signals to the power line and demodulating electronic signals from the power line.

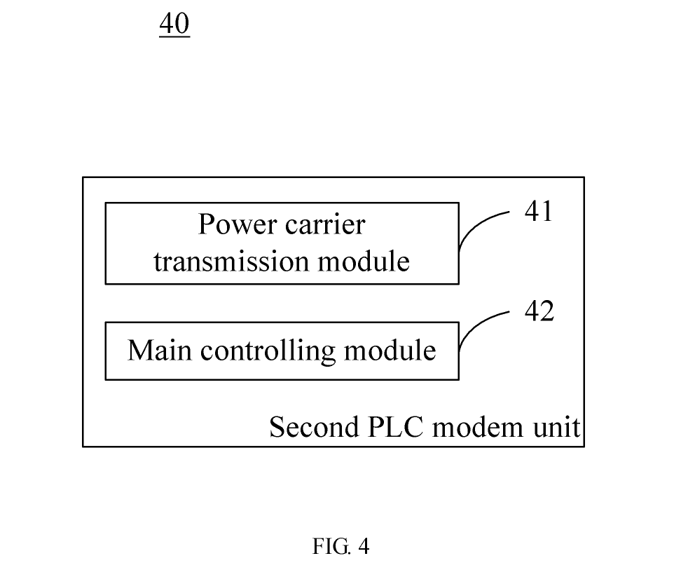

Referring to FIGS. 2 and 4, the home appliances 30 include, but are not limited to, a television 301, an air-condition 302, a lamp 303, a fridge 304, a door-keeper system, a socket, a fan, and an automatic curtain. Each of the home appliances 30 includes a second PLC modem unit 40, which is similar to the first PLC modem unit 203. The second PLC modem unit 40 includes a power carrier transmission module 41 configured for loading electronic signals to the power line and demodulating electronic signals from the power line, and a main controlling module 42 configured for data interacting, demodulating, encoding and protocol converting.

The smart gateway 20 and the home appliances 30 each include a unique identification code (ID), all of the IDs of the home appliances 30 are stored in the smart gateway 20, so that each of the home appliances 30 can be identified by the smart gateway 20. In detail, the first PLC modem unit 203 of the smart gateway 20 sends control signals that include the identification information of the target home appliance 30, and the second PLC modem unit 40 of the home appliances 30 determines whether or not the identification information of the received control signal matches their ID. Only the home appliance 30 with a matching ID parses the control signals and creates a point-to-point communication between the smart gateway 20 and the matched home appliance 30.

Referring to FIG. 2 again, the remote controller 10 includes an input unit 101, a display unit 102, a second wireless communication unit 103, and a processor unit 104. The processor unit 104 generates a corresponding controlling command according to a user's input and sends the controlling command to the smart gateway 20 via the second wireless communication unit 103. The controlling command includes an operation command and the identification information of a target home appliance 30, which is assigned to execute the operation command.

The remote controller 10 can communicate with the smart gateway 20 via a wired or wireless communication mode, wherein the wireless communication mode includes, but is not limited to, infrared, Bluetooth, Z-wave, NFC, ZIGBEE, WIFI, or other communication technologies; the wired communication mode can be Power Line Communication (hereinafter PLC), Optical Fiber Power Line Communication (hereinafter OPLC), wired Internet communication, coaxial cable communication, telephone line communication, or other communication technologies. In this embodiment, the remote controller 10 communicates with the smart gateway 20 via WIFI communication, the second wireless communication unit 103 of the remote controller 10 and the first wireless communication unit 204 of the smart gateway 20 each includes a WIFI communication module. In other embodiments, the remote controller 10 communicates with the smart gateway 20 via Infrared communication, and parts of the home appliances 30, such as the television 301 or the air-conditioner 302, also receive Infrared control signals. The remote controller 10 directly sends Infrared control signals to this kind of home appliances 30 to control them.

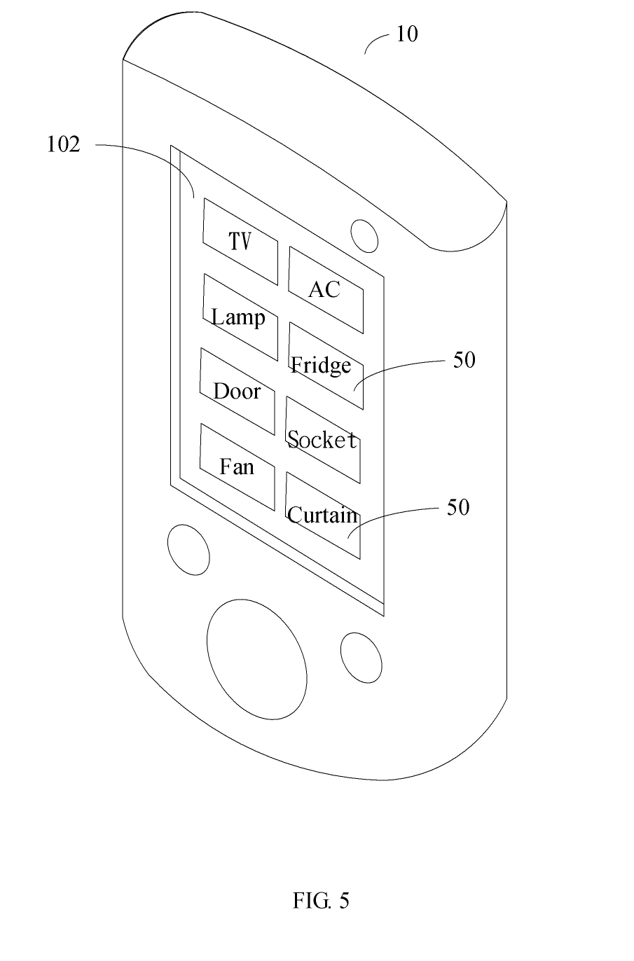

Referring to FIG. 5, an operation controlling interface of the remote controller 10 is provided. In this embodiment, the input unit 101 of the remote controller 10 is a touch screen. A controlling program is preloaded in the remote controller 10. The controlling program can be, but is not limited to, downloaded from an online APP store. The processor unit 104 of the remote controller 10 runs the controlling program to display the operation controlling interface on the display unit 102. In detail, a number of icons 50 are displayed on the operation controlling interface. Each of the icons 50 corresponds to one of the home appliances 30. For example, the operation controlling interface displayed on the display unit 102 provides a layout of a house, and the icons 50 are arranged according to the arrangement of the home appliances 30 in the house. Users can select any of the home appliances 30 via choosing the corresponding icon 50 displayed on the display unit 102 by the input unit 101. The display unit 102 of the remote controller 10 further provides an operation menu of the selected home appliance 30 for selecting. The processor unit 104 responds to a user's selection, and sends the controlling command, which includes the selected operation command and the identification information of the selected home appliance 30, to the smart gateway 20 via the second wireless communication unit 103. In other embodiments, the input unit 101 is a plurality of buttons.

In this embodiment, the server 33 can be, but is not limited to, a cloud server with cloud storage and computing functions. The system information of the smart home system 100 is also stored in the server 33, as disclosed in paragraph [0020]. The system information includes the IDs of the home appliances 30, a location and setting parameters of the smart gateway 20, and verification information of registered users of the smart home system 100. The verification information includes a user name and a secret code of the registered user.

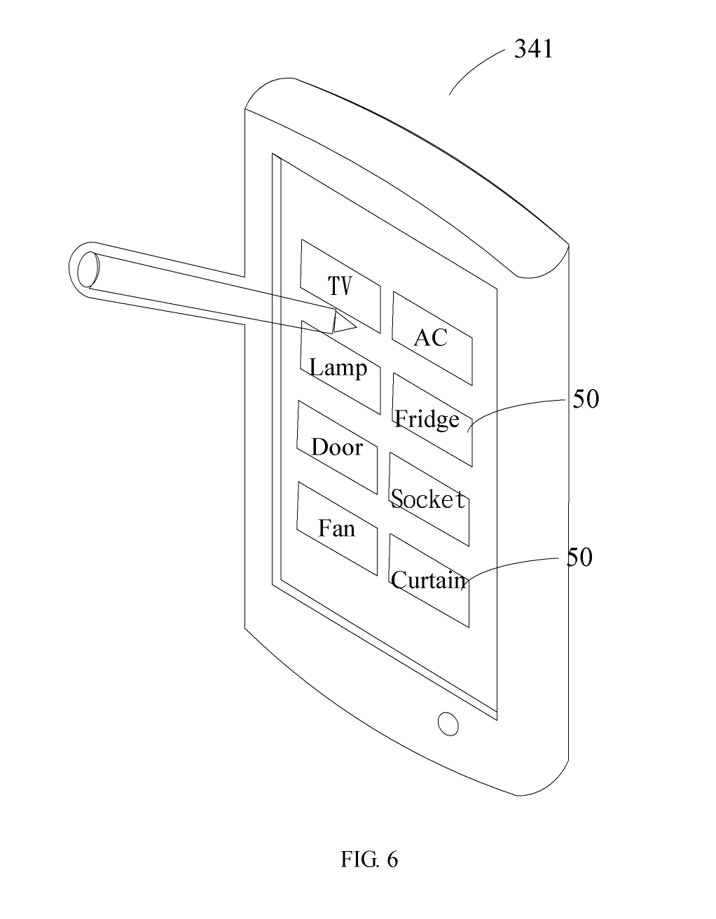

Referring to FIG. 6, in this embodiment, the Internet controller 34 is a smart portable device 341. The smart portable device 341 connects to the Internet via a WIFI (Wireless Fidelity) or WAPI (Wireless LAN Authentication and Privacy Infrastructure) network, General Packet Radio Service (GPRS) network, the Code Division Multiple Access (CDMA) network, the 3^{rd} Generation (3G) Telecommunication network or the 4^{th} Generation (4G) Telecommunication network, or the other networks of mobile Internet.

The smart portable device 341 also includes a smart home controlling program run therein. When the smart home controlling program runs in the smart portable device 341, the smart portable device 341 sends an user name and a password input by the user to the server 33. The server 33 verifies whether or not the user name and the password is valid. If yes, the server 33 sends the system information of the home system 10 related to the user name to the smart portable device 341. The smart portable device 341 displays the operation controlling interface according to the system information. The operation interface provides a building layout of the house and a plurality of icons 50 corresponding to the home appliances 30. The icons 50 are arranged according to the arrangement of the home appliances 30 in the house. The smart portable device 341 also establishes communication with the smart gateway 20 according to the location and setting parameters of the router 35. The smart portable device 341 further provides the operations menu of the selected home appliance 30 for selecting. The smart portable device 341 responds to a user's selection and sends the controlling command, which includes the selected operation command and the identification information of the selected home appliance 30, to the smart gateway 20.

In another embodiment, a peer to peer (P2P) technology is used. After the server 33 verifies the user name and the password sent by the smart portable device 341, the smart portable device 341 sends the controlling command, which includes the operation command and the identification information of the selected home appliance 30, to the router 35 directly. The router 35 transmits the controlling command to the smart gateway 20.

In another embodiment, the server 33 is a web server configured to provide the operation controlling interface. The smart portable device 341 accesses the server 33 to obtain the operation controlling interface. In detail, the server 33 verifies whether or not the user name and the password sent by the smart portable device 341 is valid, and permits the smart portable device 341 to download a web page of the operation controlling interface when the user name and the password is valid. The smart portable device 341 responds to a user's selection, and sends the controlling command including the operation command and the identification information of the selected home appliance 30 to the smart gateway 20. The operation controlling interface provides a building layout of the house and a number of icons 50 relating to the home appliances 30. The icons 50 are arranged according to the arrangement of the home appliances 30 in the house. The smart portable device 341 further provides the operations menu of the selected home appliance 30 for selecting. The smart portable device 341 responds to a user's selection and sends the controlling command, which includes the operation command and the identification information of the selected home appliance 30 to the smart gateway 20.

In other embodiments, smart phone, personal digital assistant (PDA), or tablet PC et al. that are also capable of connecting to the Internet via wireless network, such as WIFI network, can serve as the Internet controller 34. The first wireless communication unit 204 of the smart gateway 20 can establish communication to the Internet controller 34, and receives the controlling command sent by the Internet controller 34 directly. This connecting manner is suitable for short range wireless communication, the smart gateway 20 can establish communication to the Internet controller 34 directly without bridged by the server 33.

The smart gateway 20 is connected to the Internet by the Internet communication unit 201. The server 33 and the Internet controller 34 are also connected to the Internet. The Internet communication unit 201 of the smart gateway 20 transmits the controlling commands sent by the server 33 or the Internet controller 34 to the processor unit 202. The Internet communication unit 201 can be a wired Ethernet interface unit configured for connecting the smart gateway 20 to the router 35, thereby connecting the smart gateway 20 to the Internet. In other embodiments, the Internet communication unit 201 can be a WIFI or WAPI communication unit configured for connecting the smart gateway 20 to the router 35 in wireless manner.

The processor unit 202 receives the controlling commands sent by the server 33 or the Internet controller 34. The controlling command includes an operation command and the identification information of the home appliance 30, which executes the operation command. In this embodiment, the identification information is the ID of the home appliance 30. The processor unit 202 further extracts the operation command and the ID of the home appliance 30, which executes the operation command from the controlling command.

The first PLC modem unit 203 sends a controlling signal, which includes the operation command and the ID of a home appliance 30, to the home appliance 30. The home appliance 30 that has the matching ID in the controlling signal executes the operation command. In detail, the main controlling module 2032 of the first PLC modem unit 203 encodes the controlling signal according to the operation command and the ID of the home appliance 30. The power carrier transmission module 2031 loads the controlling signal to the power line for sending the controlling signal to the target home appliance 30.

The home appliance 30 receives the controlling signal sent by the smart gateway 20 via the second PLC modem unit 40, and executes the corresponding operation according to the operation command included in the controlling signal. In detail, the power carrier transmission module 41 of the second PLC modem unit 40 demodulates controlling signals from the power line and determines whether or not the ID of the controlling signal matches the ID of itself. If the IDs match, the power carrier transmission module 41 receives and parses the controlling signal; the main controlling module 42 extracts the operation command included in the controlling signal, and the home appliance 30 executes the corresponding operation according to the operation command.

The smart home system 100 is connected to the Internet. The smart gateway 20 is not only capable of receiving the controlling command sent by the remote controller 10, but also capable of receiving the controlling command sent by the server 33 or the Internet controller 34. Users can remote control the home appliance 30 in the smart home system 100 by the Internet controller 34, such as a common smart electronic device.

The first PLC modem unit 203 and the second PLC modem unit 40 communicate with each other. The ID of the smart gateway 20 is stored in the home appliance 30. Therefore, the home appliance 30 sends signals to the smart gateway 20 via power lines, and the first PLC modem unit 203 of the smart gateway 20 receives the signals via the power lines.

In other embodiments, the home appliances 30 connect to the smart gateway 20 wirelessly. Each ID of the home appliances 30 is uniquely identified by the smart gateway 20. Each of the home appliances 30 and the smart gateway 20 include a wireless communication module, such as Bluetooth, Z-wave, NFC, ZIGBEE, WIFI or WAPI communication module.

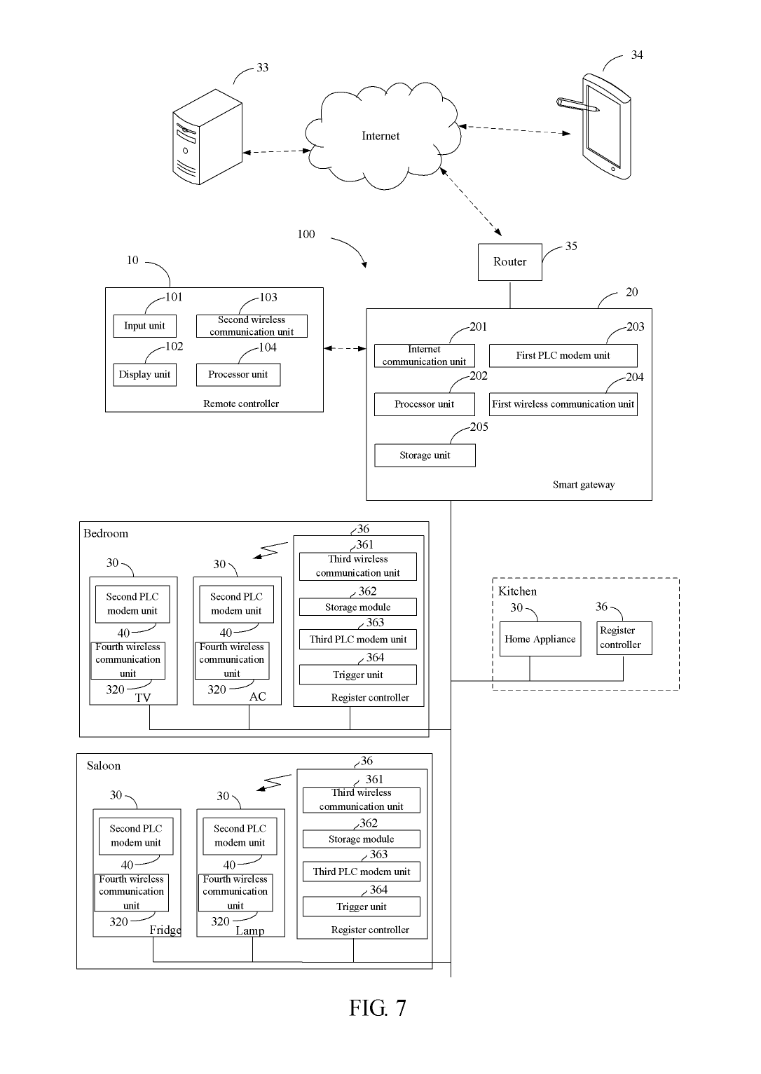

Referring to FIG. 7, the smart home system 100 further includes at least one registration controller 36. In this embodiment, the smart home system 100 includes a number of registration controllers 36 arranged in each room of the smart home system 100 correspondingly. The registration controller 36 includes a third wireless communication unit 361, a storage module 362, a third PLC modem unit 363, and a trigger unit 364. In this embodiment, the registration controllers 36 are connected to the power line, and communicate with the home appliances 30 via the PLC modem units. Each of the registration controllers 36 includes an ID stored in the storage module 362.

In this embodiment, the third wireless communication unit 361 includes an Infrared communication unit. The first wireless communication unit 204 of the smart gateway 20 also includes an Infrared communication unit. The registration controllers 36 communicate with the smart gateway 20 via Infrared communication. Each of the home appliances 30 includes a fourth wireless communication unit 320. The fourth wireless communication unit 320 also includes an Infrared communication unit for establishing communication with the registration controllers 36. The third wireless communication unit 361 sends out Infrared signals. In other embodiments, the third wireless communication unit 361 and the fourth wireless communication unit 320 can use Bluetooth, Z-wave, NFC, ZIGBEE, WIFI, or other communication technologies.

Each of the home appliances 30 needs to be registered in the smart gateway 20, so as to allow the smart gateway 20 to recognize the home appliance 30. A user uses the registration controller 36 to control the home appliances 30 in a room to automatically register with the smart gateway 20.

The registration controller 36 needs to be registered in the smart home system 100 in an initial state. To register the registration controller 36, the registration controller 36 is connected to the power and is located within the communicating range of the first wireless communication unit 204 of the smart gateway 20, and a registering program is run on the smart gateway 20. Then, the first wireless communication unit 204 of the smart gateway 20 establishes communication with the third wireless communication unit 361 of the registration controller 36, and the smart gateway 20 sends its ID to the registration controller 36. The registration controller 36 receives the ID of the smart gateway 20 and saves it in the storage module 362, thereby completing the registration process.

After registering the registration controller 36 in the smart home system 100, the home appliances 30 can be registered in the smart gateway 20. When the registration controller 36 is connected to the power line, the registration controller 36 sends a register code to the home appliances 30 located within the communication range of the registration controller 36 via the third wireless communication unit 361, and sends a register request to the smart gateway 20 via the third PLC modem unit 363, in response to a user's input on the trigger unit 364. The register code includes the ID of the smart gateway 20 and the ID of the registration controller 36, and the register request includes the ID of the registration controller 36. In this embodiment, the communication range of the registration controller 36 is within a room that the registration controller 36 is placed.

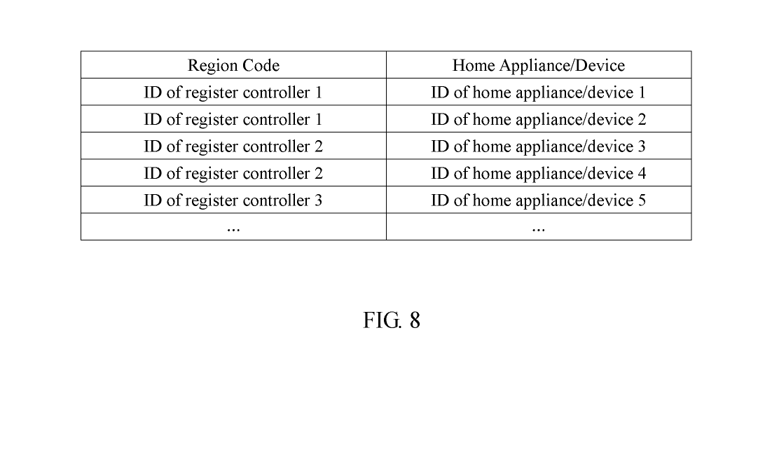

Referring to FIG. 8, each of the home appliances 30 located within the communication range of the registration controller 36 receives the register code sent by the registration controller 36 via the fourth wireless communication unit 320, and establishes communication with the smart gateway 20 according to the ID of the smart gateway 20 included in the register code. Each home appliance 30 sends a registration signal to the smart gateway 20. The registration signal includes the ID of the registration controller 36 and the ID of the home appliance 30.

The smart gateway 20 generates a region code corresponding to the ID of the registration controller 36 in response to the received register request sent by the registration controller 36. In this embodiment, the region code is the ID of the registration controller 36.

The smart gateway 20 assigns the corresponding region code to the home appliances 30 according to the ID of the registration controller 36 in the registration signal, and the IDs of the home appliances 30 and the corresponding region code are recorded in a mapping table. In this embodiment, the smart gateway 20 stores the mapping table in the system information of the home system 100.

In this embodiment, the home system 100 includes a number of registration controllers 36 distributed in each room of the home system 100. Each of the registration controllers 36 includes a unique ID. The home appliances 30 located in one room respond to the trigger of the registration controller 36 in the same room to register with the smart gateway 20. The smart gateway 20 assigns a region code to every registering home appliance 30 and stores the ID of the home appliance 30 and the region code in the mapping table. Because the IDs of the registering home appliances 30 and the IDs of the registration controllers 36 are all unique, unless the registered home appliance 30 is moved to a new room and receives a new register code sent by another registration controller 36, the region code corresponding to the ID of the home appliance 30 stored in the mapping table will not be replaced by a new region code.

In other embodiments, in response to a user's operation on the trigger unit 364, the third wireless communication unit 361 sends a register code to the home appliances 30 located within the communication range of the registration controller 36, and the third PLC modem unit 363 sends a register request to the smart gateway 20 via the PLC modem units. The smart gateway 20 calls all the electronic devices on the power line to directly send their IDs in response to the register request. In detail, the smart gateway 20 signals all the electronic devices on the power line in response to the register request to determine whether or not the ID of the registration controller 36 included in the register code received by the home appliance 30 is the same as the ID of the registration controller 36 included in the register request received by the smart gateway 20. If so, the smart gateway 20 requests the home appliances 30 to send their IDs to the smart gateway 20 via the PLC modem units.

In other embodiments, a safety certification process is carried out in the register process, either when registering the home appliance 30 on the smart gateway 20, or registering the registration controller 36 on the smart home system 100. When the registration controller 36 is registered on the smart home system 100, the first wireless communication unit 204 of the smart gateway 20 and the third wireless communication unit 361 of the registration controller 36 establishes communication with each other. The smart gateway 20 sends its ID and a code to the registration controller 36. The code can be the ID of the smart gateway 20 or a random code. The registration controller 36 encrypts the registration request with the code before sending the registration request to the smart gateway 20. The registration controller 36 also packages the code in the register code, and sends the register code to the home appliances 30. The home appliance 30 also encrypts the registration signal with the received code. In this way, only the smart gateway 20 that generates the code can decode the registration request sent by the registration controller 36 and the registration signal sent by the home appliance 30. Therefore, other smart gateways connected to the power line, such as a smart gateway in a neighbor's house, cannot obtain the details of the registration request and the registration signal, and control the home appliances 30.

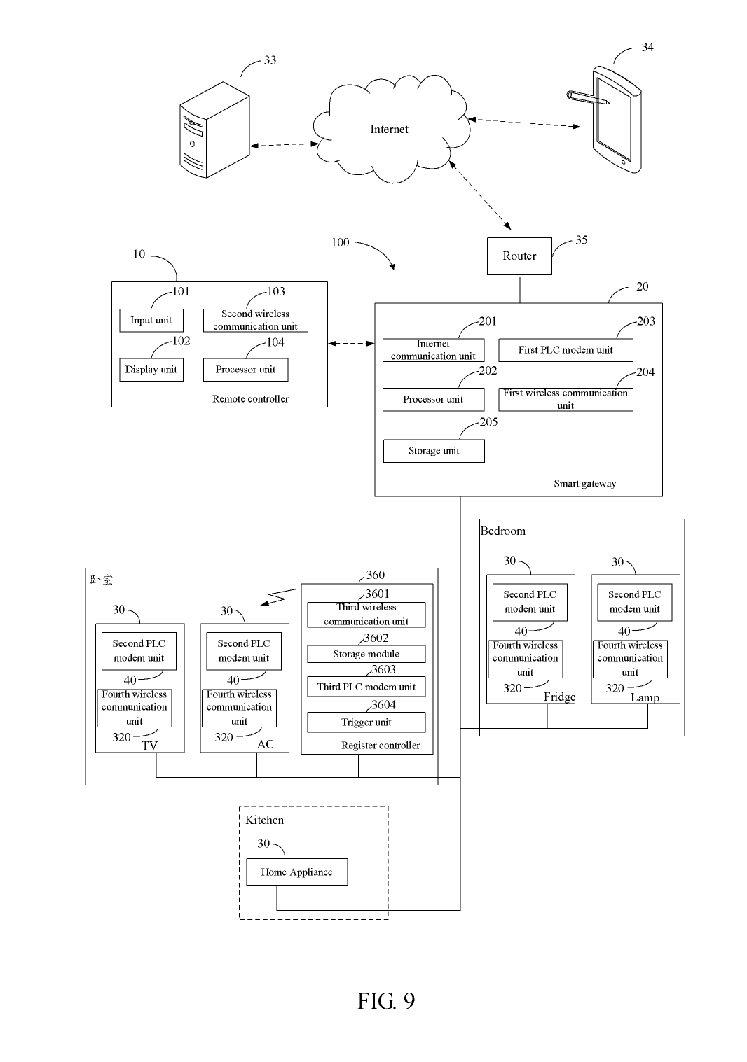

Referring to FIG. 9, in another embodiment, the smart home system 100 includes only one registration controller 360. The registration controller 360 includes a third wireless communication unit 3601, a storage module 3602, a third PLC modem unit 3603 and a trigger unit 3604. The registration controller 36 is connected to the power line, and sends a registration request to the smart gateway 20 in PLC manner to register the home appliances 30 located within the communication range of the registration controller 360.

As previously mentioned, the registration controller 360 needs to be registered in the smart home system 100 in an initial state. To register the registration controller 360, the registration controller 360 is connected to the power line, and is located within the communicating range of the first wireless communication unit 204 of the smart gateway 20, and a registering program is run on the smart gateway 20. Then, the first wireless communication unit 204 of the smart gateway 20 and the third wireless communication unit 3601 of the registration controller 360 establishes communication with each other, the smart gateway 20 sends its ID to the registration controller 360. The registration controller 360 receives the ID of the smart gateway 20 and saves it into the storage module 3602, thereby completing the registration process.

After registering the registration controller 36 in the smart home system 100, the home appliances 30 can be registered in the smart gateway 20, the registration controller 36 should be located in the room where the home appliances 30 need to be registered stand or within the communication range of this home appliances 30. The registration controller 360 sends a register request to the smart gateway 20 via the third PLC modem unit 3603, in response to a user's input on the trigger unit 3604. The register request includes the ID of the registration controller 360. The smart gateway 20 generates a serial code, and a region code composing of the serial code and the ID of the registration controller 360, the smart gateway 20 further sends the serial code to the registration controller 360.

The registration controller 360 receives the serial code via the third PLC modern unit 3603, and sent a registration code to the home appliances 30 located within the communication range of the registration controller 360 via the third wireless communication unit 3601. The registration code includes the ID of the smart gateway 20, the ID of the registration controller 36 and the serial code.

Each of the home appliances 30 located within the communication range of the registration controller 360 receives the registration code sent by the registration controller 360 via the fourth wireless communication unit 320, and establishes communication with the smart gateway 20 according to the ID of the smart gateway 20 included in the registration code. Each home appliance 30 sends a registration signal to the smart gateway 20. The registration signal includes the serial code, the ID of the registration controller 360 and the ID of the home appliance 30.

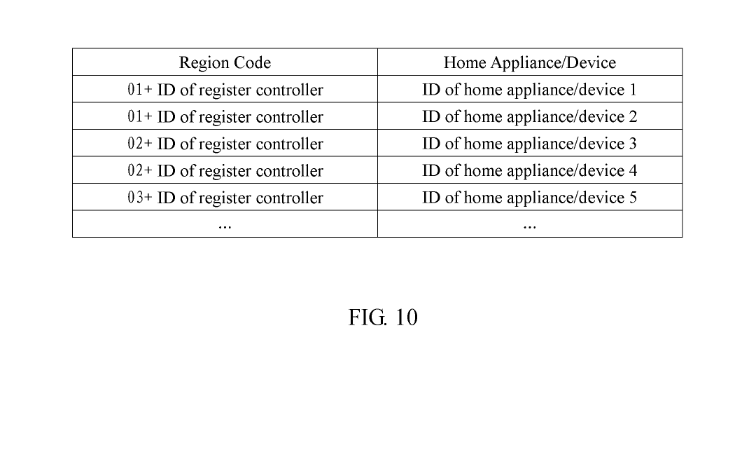

Referring to FIG. 10, the smart gateway 20 assigns the corresponding region code to the home appliance 30 according to the serial code and the ID of the registration controller 360 contained in the registration signal, and records the ID of the home appliance 30 and the corresponding region code in a mapping table.

In this embodiment, the home system 100 includes only one registration controller 360, the registration controller 360 is taken to each room of the home system 100 in turn, thus to register the home appliances 30 located in different rooms. The serial codes generated by the smart gateway 20 responding to a registration request are different in each time. Therefore, the smart gateway 20 can generates different region codes to the home appliances 30 in different room of the smart home system 100, for example, the registration controller 360 is located in a saloon of the smart home system 100, the smart gateway 20 receives a registration request and generates a first serial code, such as 01, the region code corresponds to the home appliances 30 in the saloon is composed of the first serial code “01” and the ID of the registration controller 360; then the registration controller 360 is taken to a bedroom of the smart home system 100, the smart gateway 20 receives a registration request again and generates a second serial code, such as 02, the region code corresponds to the home appliances 30 in the bedroom is composed of the second serial code “02” and the ID of the registration controller 360.

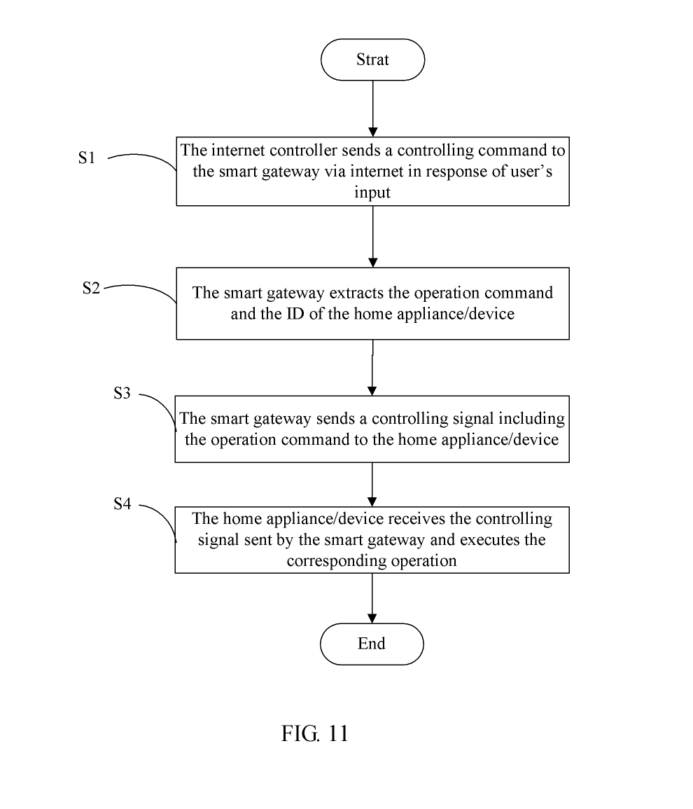

Referring to FIG. 11, a flowchart of a remote controlling method for controlling the home appliances 30 of the smart home system 100 is illustrated. The method includes the following steps, each of which is tied to various components contained in the smart home system 100 as shown in FIG. 2.

In step S1, the Internet controller 34 sends a controlling command to the smart gateway 20 via Internet in response of user's input, the controlling command includes an operation command and the ID of a home appliance 30 which is assigned to execute the operation command.

In step S2, the smart gateway 20 extracts the operation command and the ID of the home appliance 30 which is assigned to execute the operation command from the received controlling command. In detail, the Internet communication unit 201 of the smart gateway 20 receives the controlling commands sent by the server 33 or the Internet controller 34 and transmits the controlling commands to the processor unit 202, the processor unit 202 further extracts the operation command and the ID of the home appliance 30 which is assigned to execute the operation command from the controlling command. In this embodiment, the ID of the home appliance 30 is the ID of the second PLC modern unit 40.

In step S3, the smart gateway 20 sends a controlling signal including the operation command to the home appliance 30 which is assigned to execute the operation command. In detail, the main controlling module 2032 of the first PLC modem unit 203 encodes the controlling signal according to the operation command and the ID of the home appliance 30 which is assigned to execute the operation command extracted by the processor unit 202, the power carrier transmission module 2031 loads the controlling signal to the power line for sending the controlling signal to the target home appliance 30.

In step S4, the home appliance 30 receives the controlling signal sent by the smart gateway 20 and executes the corresponding operation according to the operation command included in the controlling signal. In detail, the power carrier transmission module 41 of the second PLC modem unit 40 demodulates the controlling signals from the power line and determines whether or not the ID of the controlling signal matches the ID of itself, if the IDs match, the power carrier transmission module 41 receives the controlling signal; the main controlling module 42 extracts the operation command included in the controlling signal; the home appliance 30 executes the corresponding operation according to the operation command.

In other embodiments, the smart gateway 20 communicates with each of the home appliances 30 via a wireless communication mode, wherein the wireless communication mode includes, but is not limited to, infrared, Bluetooth, Z-wave, NFC, Zigbee, WIFI, or other communication technologies. In that way, in step 4, the smart gateway 20 sends a controlling signal via the first wireless communication unit 204; in step S5, the home appliance 30 receives the controlling signal via the fourth wireless communication unit 320.

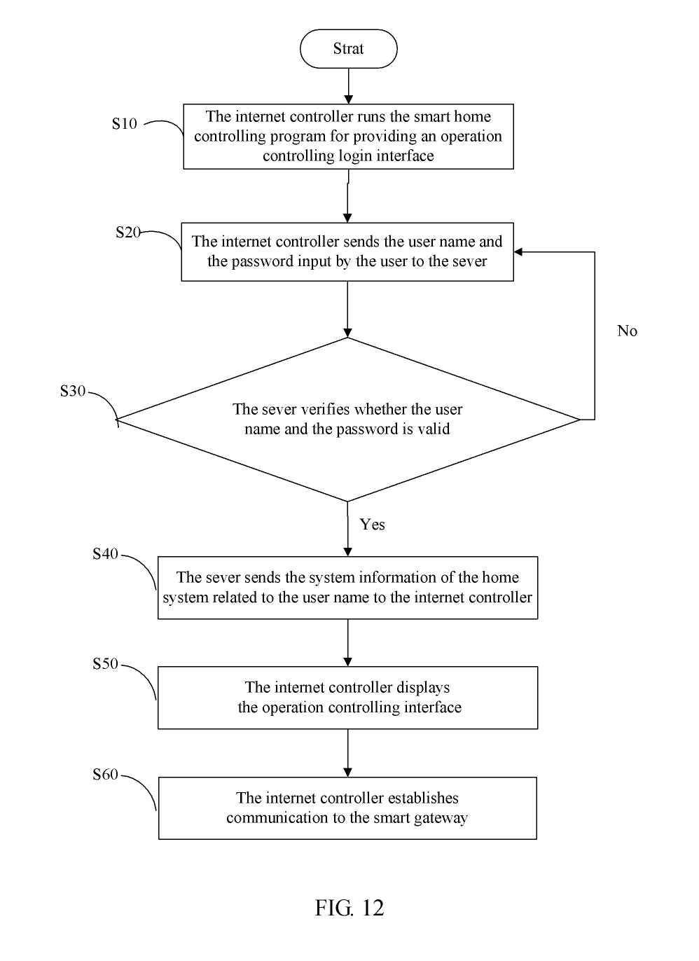

Referring to FIG. 12, the remote controlling method of the home appliances 30 of the smart home system 100 shown in FIG. 11 further includes the following steps before the step S1:

In step S10, the Internet controller 34 runs the smart home controlling program for providing an operation controlling login interface.

In step S20, the Internet controller 34 sends the user name and the password input by the user to the server 33.

In step S30, the server 33 verifies whether the user name and the password is valid, if yes, goes to step S40; if not, back to step S20.

In step S40, the server 33 sends the system information of the home system 10 related to the user name to the Internet controller 34.

In step S50, the Internet controller 34 displays the operation controlling interface.

In step S60, the Internet controller 34 establishes communication to the smart gateway 20 according to the location and setting parameters of the router 35 included in the system information.

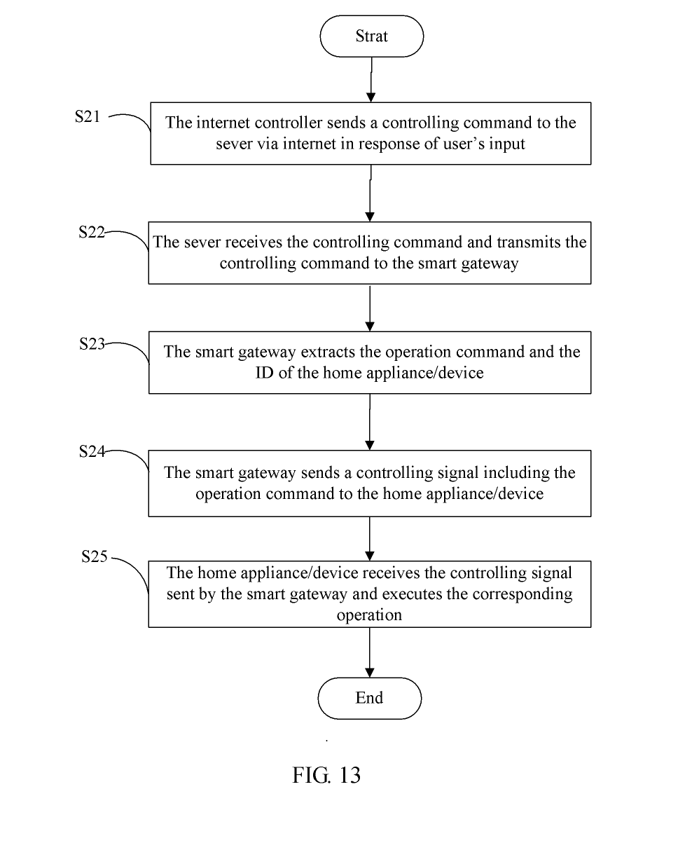

Referring to FIG. 13, a flowchart of a remote controlling method of the home appliances 30 of the smart home system 100 according to another embodiment is illustrated. The method includes the following steps, each of which is tied to various components contained in the smart home system 100 as shown in FIG. 2

In step S21, the Internet controller 34 sends a controlling command to the server 33 via Internet in response of user's input, the controlling command includes the operation command and the ID of the home appliance 30 which is assigned to execute the operation command.

In step S22, the server 33 receives the controlling command and transmits the controlling command to the smart gateway 20.

In step S23, the smart gateway 20 extracts the operation command and the ID of the home appliance 30 which is assigned to execute the operation command from the received controlling command. In detail, the Internet communication unit 201 of the smart gateway 20 receives the controlling commands sent by the server 33 or the Internet controller 34 and transmits the controlling commands to the processor unit 202, the processor unit 202 further extracts the operation command and the ID of the home appliance 30 which is assigned to execute the operation command from the controlling command. In this embodiment, the ID of the home appliance 30 is the ID of the second PLC modern unit 40.

In step S24, the smart gateway 20 sends a controlling signal including the operation command to the home appliance 30 which is assigned to execute the operation command. In detail, the main controlling module 2032 of the first PLC modem unit 203 encodes the controlling signal according to the operation command and the ID of the home appliance 30 which is assigned to execute the operation command extracted by the processor unit 202, the power carrier transmission module 2031 loads the controlling signal to the power line for sending the controlling signal to the target home appliance 30.

In step S25, the home appliance 30 receives the controlling signal sent by the smart gateway 20 and executes the corresponding operation according to the operation command included in the controlling signal. In detail, the power carrier transmission module 41 of the second PLC modem unit 40 demodulates the controlling signals from the power line and determines whether the ID of the controlling signal matches with the ID of itself, if successfully matched, the power carrier transmission module 41 receives the controlling signal; the main controlling module 42 extracts the operation command included in the controlling signal; the home appliance 30 executes the corresponding operation according to the operation command.

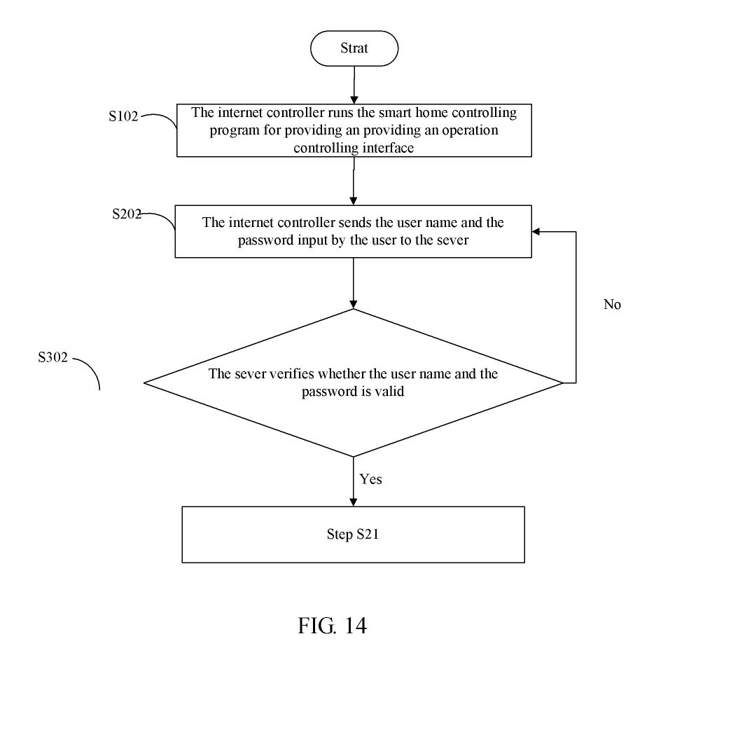

Referring to FIG. 14, the remote controlling method of the home appliances 30 of the smart home system 100 shown in FIG. 13 further includes the following steps before the step S21:

In step S102, the Internet controller 34 runs the smart home controlling program for providing an operation controlling interface.

In step S202, the Internet controller 34 sends the user name and the password input by the user to the server 33.

In step S302, the server 33 verifies whether the user name and the password is valid, if yes, goes to step S21; if not, back to step S202.

Moreover, it is to be understood that the disclosure may be embodied in other forms without departing from the spirit thereof. Thus, the present examples and embodiments are to be considered in all respects as illustrative and not restrictive, and the disclosure is not to be limited to the details given herein.

What is claimed is:

1. A remote controlling method applied to a smart home system, for controlling a plurality of home appliances of the smart home system, the smart home system comprising a remote controller, and a smart gateway communicating to the home appliances and the remote controller, the remote controlling method comprising:
S1, sending a controlling command to a smart gateway via Internet using the remote controller in response to a user's input, the controlling command comprising an operation command and an ID of a home appliance which is assigned to execute the operation command;
S2, extracting the operation command and the ID of the home appliance which is assigned to execute the operation command from the received controlling command using the smart gateway;
S3, sending a controlling signal including the operation command to the home appliance which is assigned to execute the operation command using the smart gateway;
S4, receiving the controlling signal sent by the smart gateway and executing the corresponding operation according to the operation command included in the controlling signal using the home appliance.

2. The remote controlling method as described in claim 1, wherein in step S3, the smart gateway sends the controlling signal to the home appliance via the power line by using Power Line Communication technology; in step S4, the home appliance receives the controlling signal from the power line by using Power Line Communication technology.

3. The remote controlling method as described in claim 1, further comprising the following steps before the step S1,
S10, providing an operation controlling login interface using the remote controller;
S20, sending a user name and an password input by an user to a server using the remote controller;
S30, verifying whether the user name and the password is valid using the server, if yes, goes to step S40; if not, back to step S20
S40, sending system information of the smart home system related to the user name to the remote controller using the server;
S50, displaying an operation controlling interface on the remote controller.

4. The remote controlling method as described in claim 3, further comprising step S60 following the step S50: S60, establishing communication to the smart gateway using the remote controller.

5. The remote controlling method as described in claim 1, wherein the remote controller communicates with the smart gateway via wired or wireless network technology, the wireless network technology is selected from a group consisting of infrared, Bluetooth, Z-wave, NFC, Zigbee, WIFI or WIPI communication technologies, the wired communication technology is selected from a group consisting of Power Line Communication, Optical Fiber Power Line Communication, Internet communication, coaxial cable communication, and telephone line communication technologies.

6. A smart gateway applied to a smart home system, the smart gateway communicating with a plurality of home appliances, the smart gateway comprising:
an Internet communication unit configured to connect the smart gateway to the Internet and receive a controlling command transmitted via the Internet, the controlling command comprising the operation command and the ID of the home appliance which is assigned to execute the operation command.
a processor unit configured to extract the operation command and the ID of the home appliance which is assigned to execute the operation command from the controlling command; and
a communication unit configured to send a controlling signal comprising the operation command to the home appliance which is assigned to execute the operation command according to the ID of the home appliance.

7. The smart gateway as described in claim 6, wherein the communication unit is a Power Line Communication modern unit, the Power Line Communication modern unit sends the controlling signal to the home appliance via power line.

8. The smart gateway as described in claim 6, further comprising a first wireless communication unit configured to establish communication to a remote controller, and receive the controlling commands sent by the remote.

9. The smart gateway as described in claim 6, wherein the smart gateway communicates with an Internet controller and a server via the Internet communication unit, the smart gateway receives the controlling command sent by the Internet controller and the server.

10. The smart gateway as described in claim 6, wherein the communication unit is based on wired or wireless network technology, the wireless network technology is selected from a group consisting of infrared, Bluetooth, Z-wave, NFC, Zigbee, WIFI or WIPI communication technologies, the wired communication technology is selected from a group consisting of Power Line Communication, Optical Fiber Power Line Communication, Internet communication, coaxial cable communication, and telephone line communication technologies.

11. A smart home system, comprising a plurality of home appliances and a smart gateway connected to the Internet and communicating with a plurality of home appliances, the smart gateway comprising:
an Internet communication unit configured to connect the smart gateway to the Internet and receive a controlling command transmitted via the Internet, the controlling command comprising an operation command and an ID of a home appliance which executes the operation command;
a central processor unit configured to extract the operation command and the ID of the home appliance which executes the operation command from the controlling command; and
a communication unit configured to send a controlling signal comprising the operation command to the home appliance which executes the operation command according the ID of the home appliance;
the home appliance configured for receiving the corresponding controlling signal sent by the smart gateway, and executing the corresponding operation according the operation command included in the controlling signal.

12. The smart home system as described in claim 11, wherein the communication unit is a first Power Line Communication modern unit, the first Power Line Communication modern unit sends the controlling signal to the home appliances via power line; each of the home appliances comprises a second Power Line Communication modern unit configured to receive controlling signal from the power line.

13. The smart home system as described in claim 11, wherein the smart home system comprises a remote controller, the smart gateway comprises a first wireless communication unit configured to establish communication to a remote controller, and receiving the controlling commands sent by the remote; the remote controller comprises:
an input unit configured to receive user's input;
a processor unit sends configured to generate the controlling command comprising the operation command and the ID of the home appliance which executes the operation command; and
a second wireless communication unit configured to establish communication to the first wireless communication unit and sending the controlling command to the smart gateway.

14. The smart home system as described in claim 11, wherein the server is a cloud server.

15. The smart home system as described in claim 12, wherein the smart gateway comprising a unique ID stored therein, each of the home appliances comprising a unique ID stored therein and a fourth wireless communication unit, the smart home system further comprises a registration controller comprising:
a storage module configured to store the unique ID of the registration controller;
a trigger unit configured to start the home appliances to automatically register on the smart gateway in response to user's input;
a third wireless communication unit configured to communicate with the fourth wireless communication unit of the home appliances, and sending a register code to the home appliances located within the communication range of the registration controller, the register code includes the ID of the smart gateway and the ID of the registration controller; and
a third Power Line Communication modern unit configured to send a register request to the smart gateway, the register request includes the ID of the registration controller;
the smart gateway configured for obtaining the ID of the home appliances which receive the register code in response to the register request.

16. The smart home system as described in claim 15, wherein the home appliance is configured for sending the ID thereof to the smart gateway via the second Power Line Communication modern unit in response of the register code.

17. The smart home system as described in claim 15, wherein the smart gateway generates a serial code corresponding to the ID of the registration controller in response of the received register request, the first Power Line Communication modern unit sends of the smart gateway send the serial code to the registration controller; the registration controller receives the serial code via the third PLC modern unit, and sent a registration code to the home appliances located within the communication range of the registration controller via the third wireless communication unit, the registration code includes the ID of the smart gateway, the ID of the registration controller and the serial code.

18. The smart home system as described in claim 11, wherein the communication unit is based on wired or wireless network technology, the wireless network technology is selected from a group consisting of infrared, Bluetooth, Z-wave, NFC, ZIGBEE, WIFI or WIPI communication technologies, the wired communication technology is selected from a group consisting of Power Line Communication, Optical Fiber Power Line Communication, Internet communication, coaxial cable communication, and telephone line communication technologies.
